(19) United States
(12) Patent Application Publication
(10) Pub. No.: US 2014/0302421 A1
(43) Pub. Date: Oct. 9, 2014

(54) ELECTRODE FOR ELECTROCHEMICAL CELL AND METHOD OF MANUFACTURING SUCH AN ELECTRODE

(71) Applicants: AREVA, Paris (FR); ARMINES, Paris Cedex 06 (FR); CENTRE NATIONAL DE LA RECHERCHE SCIENTIFIQUE (C.N.R.S.), Paris (FR)

(72) Inventors: Béatrice Sala, Saint Gely Du Fesc (FR); Frédéric Grasset, Montpellier (FR); Elodie Tetard, Montpellier (FR); Kamal Rahmouni, Montpellier (FR); Abdelkader Sirat, Montpellier (FR); Dominique Goeuriot, Monistrol Sur Loire (FR); Baroudi Bendjeriou, Saint-Etienne (FR); Hisasi Takenouti, Ollainville (FR)

(73) Assignee: CENTRE NATIONAL DE LA RECHERCHE SCIENTIFIQUE (C.N.R.S.), Paris (FR)

(21) Appl. No.: 14/350,783

(22) PCT Filed: Oct. 10, 2012
(86) PCT No.: PCT/EP2012/070011

§ 371 Date: Apr. 9, 2014

(30) Foreign Application Priority Data
Oct. 12, 2011 (FR) 1159224

(51) Int. Cl. H01M 4/90; H01M 4/88; C25B 11/04

(52) U.S. Cl. CPC H01M 4/9033; C25B 11/04; H01M 4/8875
USPC 429/489; 204/291; 204/242; 264/618

(57) ABSTRACT

The invention relates to an electrode for an electrochemical cell which exhibits good electron conductivity and good chemical conductivity, as well as good cohesion with the solid electrolyte of the electrochemical cell. To do this, this electrode is made from a ceramic, which is a perovskite doped with a lanthanide having one or more degrees of oxidation and with a complementary doping element taken from the following group: niobium, tantalum, vanadium, phosphorus, arsenic, antimony, bismuth.

### TECHNICAL FIELD

This invention relates to an electrode for an electrochemical cell, an electrochemical cell comprising such an electrode and a method of making such an electrode.

### STATE OF PRIOR ART

An electrochemical cell used particularly for electrolysers or fuel cells at medium and high temperatures usually comprises two electrodes between which there is a solid electrolyte.

A solid electrolyte is usually formed by a doped ceramic oxide that at the working temperature is in the form of a crystalline lattice with oxide ion vacancies. The associated electrodes are usually made from cermets that comprise ceramic and metal. More precisely, the cermets used in electrodes are composed for example of a perovskite mixed with a metal. Perovskites are materials with an ABO₃ or AA′BB′O₆ type crystalline structure in which A and A′ are lanthanides or actinides and B and B′ are transition metals, based on the natural perovskite CaTiO₃ structure.

### PRESENTATION OF THE INVENTION

The invention aims at disclosing an electrode with mixed electron and proton conductivity, electron conductivity being better than with electrodes according to prior art.

Another purpose of the invention is to disclose an electrode with good adhesion to the solid electrolyte.

Another purpose of the invention is to disclose an electrode that can be made at a lower temperature than electrodes according to prior art.

To achieve this, a first aspect of the invention discloses an electrode for an electrochemical cell with mixed electron and proton conductivity, said electrode comprising a ceramic, said ceramic being a perovskite doped with a lanthanide with one or several degrees of oxidation, said ceramic being doped with an additional doping element taken among the group composed of niobium, tantalum, vanadium, phosphorus, arsenic, antimony, bismuth.

The fact that the ceramic is doped with niobium, tantalum, vanadium, phosphorus, arsenic, antimony or bismuth makes the ceramic capable of conducting electrons. The ceramic then conducts electrons and protons, while if these doping elements are not present, the perovskite doped with a lanthanide with a single degree of oxidation does not conduct electrons.

Therefore, the invention can be used to make an electrode from a material with the same nature as the solid electrolyte that has good conductivity of both protons and electrons, even when the ceramic is not mixed with a metal.

The electrode according to the invention can also have one or several of the following characteristics taken individually or in any technically possible combination.

The lanthanide is preferably chosen from among lanthanides with one or several degrees of oxidation: ytterbium, thulium, dysprosium, terbium, europium, samarium, neodymium, praseodymium, cerium, promethium, gadolinium and holmium.

According to one embodiment, the electrode also comprises a metal; the metal and the ceramic then form a cermet. The presence of this metal can further increase the electronic conductivity of the electrode.

Advantageously, the perovskite used is a zirconate.

The lanthanide used is preferably erbium due to its size and monovalence 3.

A second aspect of the invention also relates to an electrochemical cell comprising two electrodes according to a first aspect of the invention, and a solid electrolyte placed between the two electrodes.

Advantageously, the perovskite used in the solid electrolyte is of the same nature as that used in the electrodes, which can give better cohesion between the electrodes and the electrolyte. However, the perovskite in the electrolyte will be doped with a lanthanide element with a single degree of oxidation, while the lanthanide in the electrodes may have one or several degrees of oxidation.

The electrochemical cell is advantageously an electrochemical cell of an electrolysis device such as high temperature electrolysers comprising a membrane with ionic conductivity. The invention is also applicable to fuel cells, typically of the SOFC or PCEC type to which technological developments of high temperature electrolysers are directly applicable.

A third aspect of the invention relates to a method of making an electrode based on the first aspect of the invention, the method comprising the following steps:
(a) Synthesis of a perovskite powder doped with a lanthanide with one or several degrees of oxidation;
(b) Synthesis of a powder of an additional compound comprising a doping element taken among the group composed of niobium, tantalum, vanadium, phosphorus, arsenic, antimony and bismuth, the additional compound being such that the degree of oxidation of the doping element in this additional compound is greater than or equal to 5;
(c) Mix the doped perovskite powder and the additional compound;
(e) Sinter this mix, the additional compound being such that the degree of oxidation of the doping element can reduce during sintering.

Advantageously, the lanthanide that dopes the perovskite has a single degree of oxidation when the electrolyte is manufactured, and one or several degrees of oxidation when the electrodes are manufactured.

This method is particularly advantageous because the additional compound provides oxygen to the mix of powders during sintering due to the reduction in the degree of oxidation of the doping element during sintering, so that sintering can be done in atmospheres that are not or are only slightly oxidising (i.e. an almost non-oxidising atmosphere) and at lower temperatures than is possible in methods according to prior art.

A non-oxidising or slightly oxidising atmosphere means an atmosphere with a dew point of less than −56° C. and preferably −70° C. A dew point of −70° C. corresponds approximately to a pressure PH₂O in H₂O of 2.6×10⁻⁶ atm and a pressure PO₂ in O₂ of 2.3×10⁻²⁰ atm corresponding to equilibrium at a sintering temperature of 1540° C.

Advantageously, the perovskite powder and the powder of the additional compound are mixed with a metallic powder or a metallic phase precursor so as to make a cermet, which can give an electrode with very good electron conductivity.

If the electrode has a metallic phase, sintering is done under a non- oxidising atmosphere.

Therefore, the method is capable of sintering under a non-oxidising atmosphere at temperatures less than temperatures used in methods according to prior art. For example, the sintering temperature of a strontium zirconate doped with erbium under hydrogenated argon can be reduced by 100° C. by the addition of 0.4 wt % of ZnNb₂O₆.

Advantageously, the method also comprises a step (d) for compaction of the mix between the mixing step (c) and the sintering step (e).

The invention also relates to a method of making an electrochemical cell. In this case, the method according to the third aspect of the invention also comprises a step between steps (c) and (e), and preferably between steps (c) and (d), in which a stack is made comprising at least two layers formed from a mix of the doped perovskite powder and the additional compound, between which there is an interlayer comprising a layer of perovskite powder.

The stack may also comprise two intermediate layers, each intermediate layer being located between the interlayer and one of the two layers formed from the mix of the doped perovskite powder and the additional compound. These intermediate layers will be used either as a protective layer of the electrolyte to prevent the diffusion of species between the electrodes and the electrolyte, or as accommodation layers if there are differences between the coefficients of thermal expansion of the electrode and electrolyte layers, particularly due to the presence of metal in the electrodes.

A fourth aspect of the invention relates to a method of manufacturing an electrode based on the first aspect of the invention, the method comprising the following steps:
(a) Direct synthesis of a perovskite powder doped with a lanthanide with one or several degrees of oxidation containing an additional compound comprising a doping element taken among the group composed of niobium, tantalum, vanadium, phosphorus, arsenic, antimony, bismuth, the additional compound being such that the degree of oxidation of the doping element in this additional compound is greater than or equal to 5;
(b) Sintering of said powder, the additional compound being such that the degree of oxidation of the doping element can reduce during sintering.

### DESCRIPTION OF THE FIGURES

Other characteristics and advantages of the invention will become clearer after reading the following detailed description given with reference to the appended figures that show:

FIG. 1, a diagrammatic representation of an electrochemical cell according to one embodiment of the invention;

FIG. 2, a diagrammatic representation of the steps in a method according to the invention.

Identical or similar elements are marked by identical reference symbols in all figures, to improve clarity.

### DETAILED DESCRIPTION OF AT LEAST ONE EMBODIMENT

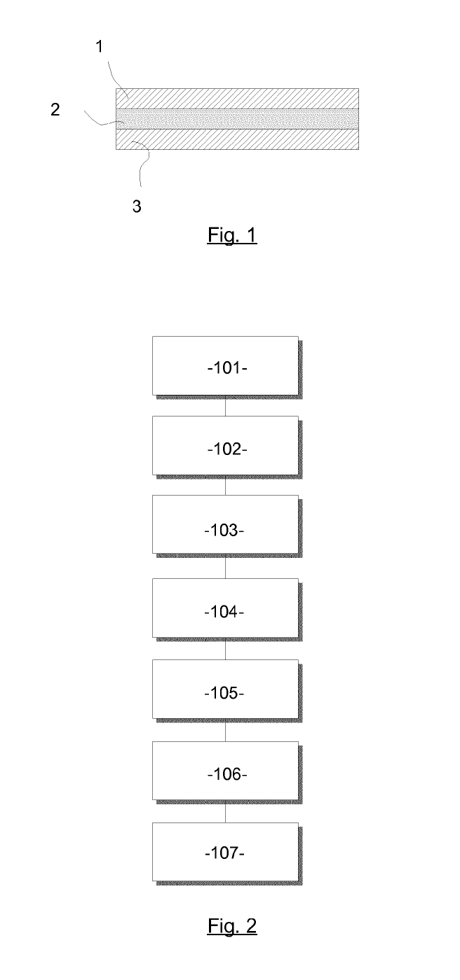

FIG. 1 shows an electrochemical cell according to one embodiment of the invention. This electrochemical cell comprises two electrodes 1, 3 between which there is a solid electrolyte 2. Each electrode 1, 3 is an electrode according to the first aspect of the invention.

Each electrode 1, 3 is made from a ceramic material that is a perovskite doped with a lanthanide. In this example, the perovskite is a zirconate with formula AZrO₃. The zirconate is dope by a lanthanide that in this case is erbium. Furthermore, the perovskite doped with the lanthanide is doped with a doping element from among the group composed of niobium, tantalum, vanadium, phosphorus, arsenic, antimony and bismuth. These doping elements are chosen to dope the ceramic because they can change from a degree of oxidation equal to 5 to a degree of oxidation of 3, which releases oxygen during sintering as we will see later. More precisely, the doping element is preferably niobium or tantalum. Each electrode may also comprise a metal mixed with ceramic to form a cermet.

In this example embodiment, the ceramic comprises between 0.1% and 0.5% by mass of niobium, between 4 and 4.5% by mass of erbium and the remainder in zirconate.

The electrochemical cell in FIG. 1 is manufactured according to the method described with reference to FIG. 2. The first step is to synthesise a perovskite powder doped with a lanthanide during a step 101. The ceramic thus obtained is in the form of large aggregates composed of nanometric grains. This ceramic is then formulated to reduce the size of its grains to obtain a grain size distribution that will be conducive to compaction of the powder.

A powder of an additional compound comprising a doping element from among the group composed of niobium, tantalum, vanadium, phosphorus, arsenic, antimony and bismuth, is also synthesised during a step 102, the additional compound being such that the degree of oxidation of the doping element is greater than or equal to 5 in this additional compound. This additional compound may for example by a niobiate, in other words a compound comprising niobium, or a tantalate, in other words a compound comprising tantalum. The niobiate used may for example be zinc niobiate with formula ZnNb₂O₆.

The next step is to mix the doped perovskite powder obtained in step 101 and the powder of the additional compound obtained in step 102, in a step 103. This mix may for example comprise between 0.1% and 0.5% by mass of zinc niobiate.

The mix thus obtained can then be mixed with a metal powder so as to form a cermet, during a step 104.

A step 105 can then be made to form a stack that will subsequently form the electrochemical cell and that comprises two layers formed from the mix of doped perovskite powder and the powder of the additional compound, between which there is an interlayer comprising a layer of perovskite powder. The two layers formed from the mix of doped perovskite powder and the powder of the additional compound will each form the electrodes of the electrochemical cell, while the interlayer will form the solid electrolyte. The stack may also comprise two intermediate layers, each intermediate layer being placed between the interlayer and one of the two layers formed from the mix of the doped perovskite powder and the additional compound. These intermediate layers will act either as the electrolyte protective layer to prevent diffusion of species between the electrodes and the electrolyte, or as accommodation layers if there are any differences between the coefficients of thermal expansion of the electrode and electrolyte layers, particularly due to the presence of metal in the electrodes.

The stack thus obtained can then be compacted during a step 106, and then sintered during a step 107.

The manufacturing process is particularly advantageous because the degree of oxidation of the doping element will reduce during sintering, usually from +5 to +3, such that the additional compound releases oxygen.

It is thus possible to sinter at a lower temperature due to this added oxygen. Thus for example, if the perovskite used is a zirconate doped with erbium and mixed with zinc niobiate, sintering can take place at 1415° C.

Advantageously, sintering is done under a reducing atmosphere, in other words an atmosphere of hydrogen (H₂) and argon (Ar).

The electrode thus obtained has good cohesion with the electrolyte.

The electrode thus obtained also has enhanced electron conductivity and good proton conductivity. The ratio of electron conductivity to proton conductivity of the electrode thus obtained is equal to approximately 100.

Naturally, the invention is not limited to the embodiments described with reference to the figures, and variants could be envisaged without going outside the scope of the invention. In particular, the proportions of the different materials are given only for illustration. The geometry of the electrochemical cell could also be different from the disclosed geometry.

1. An Electrode for an electrochemical cell with mixed electron and proton conductivity, said electrode comprising a ceramic, said ceramic being a perovskite doped with a lanthanide with one or several degrees of oxidation, characterised in that said ceramic is doped with an additional doping element taken among the group composed of niobium, tantalum, vanadium, phosphorus, arsenic, antimony, bismuth.

2. The Electrode according to claim 1, also comprising a metal, the metal and the ceramic forming a cermet.

3. The Electrode according to claim 1, in which the perovskite used is a zirconate.

4. An Electrochemical cell comprising two electrodes according to claim 1 and a solid electrolyte arranged between the two electrodes.

5. The Electrochemical cell according to claim 4, in which the solid electrolyte is made from a perovskite doped with a lanthanide with one degree of oxidation, the perovskite used in the solid electrolyte being of the same nature as that used in the electrodes.

6. A method of making an electrode according to claim 1, comprising the following steps:
(a) Synthesis of a perovskite powder doped with a lanthanide with one or several degrees of oxidation;
(b) Synthesis of a powder of an additional compound comprising a doping element taken among the group composed of niobium, tantalum, vanadium, phosphorus, arsenic, antimony and bismuth, the additional compound being such that the degree of oxidation of the doping element in this additional compound is greater than or equal to 5;
(c) Mix the doped perovskite powder and the additional compound;
(d) Sinter this mix.

7. The Method according to claim 6, in which sintering is done in an almost non-oxidising atmosphere. (Currently Amended) The Method according to claim 6, in which the perovskite powder and the powder of the additional compound are also mixed with a metallic powder or a metallic phase precursor.

8. The Method according to claim 6, also comprising a step between steps (c) and (d), in which a stack is made comprising at least two layers formed from a mix of the doped perovskite powder and the additional compound, between which there is an interlayer comprising a layer of perovskite powder.

9. The Method according to claim 8, in which the stack also comprises two intermediate layers, each intermediate layer being located between the interlayer and one of the two layers formed from the mix of the doped perovskite powder and the additional compound.

10. A Method of manufacturing an electrode according to claim 1, the method comprising the following steps:
(a) Direct synthesis of a perovskite powder doped with a lanthanide with one or several degrees of oxidation containing an additional compound comprising a doping element taken among the group composed of niobium, tantalum, vanadium, phosphorus, arsenic, antimony, bismuth, the additional compound being such that the degree of oxidation of the doping element in this additional compound is greater than or equal to 5;
(b) Sintering of said powder, the additional compound being such that the degree of oxidation of the doping element can reduce during sintering.
